(19) United States
(12) Patent Application Publication
(10) Pub. No.: US 2020/0106679 A1
(43) Pub. Date: Apr. 2, 2020

(54) COMPUTATIONAL RATING OF ELECTRONIC COMMUNICATION MECHANISMS

(71) Applicant: Microsoft Technology Licensing, LLC, Redmond, WA (US)

(72) Inventors: Yayuan Hu, Sunnyvale, CA (US); Wenjing Zhang, Menlo Park, CA (US); Haowen Cao, Sunnyvale, CA (US)

(21) Appl. No.: 16/144,996

(22) Filed: Sep. 27, 2018

(51) Int. Cl. H04L 12/24; G06F 3/0481

(52) U.S. Cl. CPC H04L 41/22; G06F 3/0481

(57) ABSTRACT

The disclosed technologies computationally produce ratings data for candidate communication mechanisms. In an embodiment, the disclosed technologies include, in response to an interaction of a first entity with a set of software-based user interface elements, determining candidate communication mechanisms usable by the first entity to establish a bidirectional network communication between the first entity and a second entity, where the first entity and the second entity are represented by first and second data nodes, respectively, in a connection graph that is coupled to online software, where the first and second data nodes are not directly connected to each other through the connection graph; generating quantitative data that represents a measure of activity involving at least the second data node and the online software; converting the quantitative data to an ordinal data value that represents a predicted success of a corresponding one of the candidate communication mechanisms in establishing the bidirectional network communication between the first entity and the second entity; causing incorporating the ordinal data value into the set of user interface elements while the first entity is interacting with management software or the online software.

### TECHNICAL FIELD

The present disclosure relates to online connection networks and related computing systems, and more particularly to techniques for establishing electronic communication between entities on a connection network.

### BACKGROUND

In a connection network, a node can be considered reachable by another node if there is a path between the two nodes. A path can include one or more connections, which also may be referred to as links or edges, and zero or more intermediate nodes. When two nodes are connected by a path that does not include any intermediate nodes, the nodes may be considered directly connected to one another.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1A is a flow diagram of a process, in an embodiment;

FIG. 1B is a block diagram of a software-based system, in an embodiment;

FIG. 1C is a block diagram of a networked computing environment, in an embodiment;

FIG. 2 is a flow diagram of a process, in an embodiment;

FIG. 3 is an example screen capture, in an embodiment;

FIGS. 4A and 4B are example screen captures, in an embodiment;

FIG. 5 is a block diagram that illustrates a hardware environment upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

Entities that are represented by nodes on a connection network often seek to establish direct bidirectional communication with one another, such as through electronic messaging. This need often arises where the nodes are not directly connected, but may arise even if a direct connection already exists between the nodes.

That is, while the lack of a direct connection between nodes may be a strong indicator of a lack of bidirectional electronic communication between entities represented by the unconnected nodes, the existence of a direct connection between the nodes does not guarantee that the desired type of bidirectional electronic communication has been established between the corresponding entities. For example, an automatically generated message that simply indicates that an entity's connection request has been accepted may not be considered as having established bidirectional communication since the entity that accepted the connection request may have had minimal or no meaningful participation in the generation of the communication back to the requesting entity.

Through various network-based services, a variety of different communication mechanisms may be available for use by an entity to attempt to achieve the objective of establishing bidirectional electronic communication with another entity. Use of an entity associated with an intermediate node to facilitate an electronic introduction is one form of communication mechanism that an entity may use to try to establish bidirectional communication with another entity, where the entities are represented by nodes on a connection network. Electronic messaging, such as direct entity-to-entity electronic messaging through an online messaging service, is another type of communication mechanism that may be useful for this purpose.

While it may seem counterintuitive, the availability of multiple different communication mechanisms actually can delay the establishment of a bidirectional communication between entities. This is because the effectiveness of a communication mechanism in successfully achieving the objective of establishing bidirectional communication with a particular entity is often uncertain. Uncertainty as to how use of a communication mechanism will be received by the targeted entity can result in the communication mechanism remaining unused altogether.

The effectiveness of a particular communication mechanism may vary significantly from entity to entity, as different entities may use certain communication mechanisms more frequently than others. Additionally, some entities may use certain communication mechanisms for certain specific purposes but not for other purposes. Thus, the effectiveness of a particular communication mechanism can depend not only on preferences or practices of the entity that is the target of the request but also the preferences or practices of the entity that wishes to initiate the bidirectional communication with the target.

The effectiveness of a communication mechanism also may be uncertain because the sharing of data that is required to be analyzed in order to predict effectiveness of a communication mechanism may be restricted, for example by privacy rules or security policies. Such restricted data may include the number of connections an entity's data node has with particular other nodes on the connection network, the identities of the entities associated with those other nodes, entity profile or preference information, as well as the entity's frequency and patterns of viewing and responding to electronic messages from other entities using the connection network.

This disclosure describes technologies for computationally generating ratings data for communication mechanisms, where the ratings data is specific to a particular second entity with which bidirectional electronic communication is sought to be established by a first entity and the first and second entities are represented by first and second data nodes, respectively, on a connection network. In some implementations, the data nodes representing the first and second entities are not directly connected to one another on the connection network.

The disclosed technologies can improve the likelihood of establishing a desired bidirectional communication between entities that use a connection network, particularly in instances where the first and second data nodes are not directly connected or where detailed information about the second entity's communication preferences may not be readily available to the first entity due to data access restrictions or other reasons.

In one approach, candidate communication mechanisms are identified in response to an interaction by a first entity with a set of user interface elements of management software or online software. In some implementations, the interaction is detected while the management software or online software is presenting data associated with a second data node, where the second data node represents a second entity on the connection network. For example, the interaction may include the first entity viewing the second entity's profile information through an online service for a threshold length of time.

Candidate communication mechanisms may be presented in the alternative or may supplement one another. For example, the candidate communication mechanisms may be prioritized based on ratings data that is made available to the first entity through the use of the disclosed technologies. For each candidate communication mechanism that is identified, quantitative data is generated.

When the candidate communication mechanism involves an online introduction through an intermediate node, the quantitative data includes a measure of online activity involving at least the second data node. In some implementations, this quantitative data measures the relative strengths of candidate connector nodes. The term “candidate connector node” may refer to an intermediate node that is capable of facilitating an introduction to the second entity, that is the entity with whom a bidirectional communication is sought by the first entity. The candidate connector node may have a direct connection with a node of the first entity and with a node of the second entity. In some implementations, the relative strength of a particular candidate connector node is computed based on the number of connections that the candidate connector node has in common with both the first and second data nodes on the connection network. A highest ranking candidate connector node, as determined based on the computed connection strength data, is then identified to the first entity through user interface elements.

Where the candidate communication mechanism involves direct electronic messaging, the quantitative data indicates a messaging interaction rate of the second entity, where the interaction rate is associated with the processing of electronic messages that have been received by the second entity during a time interval. For example, the interaction rate for messaging may be computed based on recent historical interaction data of the second entity, and may represent a rate at which the second entity has viewed or responded to direct electronic messages during a time interval.

The quantitative data may further include counts of date and time stamp data that are associated with message view and reply interactions of the second entity during the time interval. In some implementations, the date and time stamp data are used to predict a best date and/or time for the first entity to use electronic messaging to contact the second entity.

In some implementations, the quantitative data may further include content interaction rate data that is determined based on recent historical news feed interaction data of the second entity. In this case, the interaction rate data is indicative of the frequency and timing of the second entity's interactions with various content items of an electronic news feed that may be provided in connection with the online service, over a time interval. Links to specific content of the news feed with which the second entity interacted also may be obtained and associated with the interaction rate data, in some embodiments.

For each candidate communication mechanism that is identified, the quantitative data generated for that communication mechanism is converted to an ordinal data value. In some implementations, the ordinal data value is a positive integer representative of a star rating. In some implementations, a higher ordinal data value corresponds to a higher number of stars, indicating a higher likelihood that the candidate communication mechanism will be successful in establishing bidirectional communication between the particular first and second entities.

Conversely, a lower ordinal data value may correspond to a lower number of stars, indicating a lower likelihood that the candidate communication mechanism will be successful in establishing the bidirectional communication between the particular first and second entities.

The converting of the quantitative data to an ordinal data value helps preserve access restrictions that may pertain to the quantitative data, for example where protecting the privacy of the quantitative data may be a concern. Generation of the ordinal data value as disclosed herein enables prediction of a likelihood of success for a candidate communication mechanism without revealing potentially sensitive or private information about the entities involved or their use of the connection network. In all instances in which use of potentially sensitive or private data is described in this disclosure, such use is assumed to be in compliance with all applicable data privacy laws, rules, regulations, policies, and user preferences.

In contrast to many typical star ratings that are subjective in nature (generated based on user comments, for example), the disclosed ordinal data values are computationally generated based on quantitative data. This, the disclosed approach to generating ratings data produces ratings data that is objectively verifiable rather than dependent on subjective user inputs.

Approaches described herein address the technical problem of establishing bidirectional communication between entities represented by data nodes on a connection network, and more particularly between entities whose nodes are not directly connected on the connection network. The disclosed approaches improve upon known systems by, among other things, facilitating the selection and activation of a communication mechanism that is more likely to result in the desired bidirectional communication being successfully established.

A benefit that may be realized by at least some embodiments described herein includes automatic rating of alternative communication mechanisms, where the rating is specific to a particular target entity, without the need to disclose information that may be considered sensitive or private by the target entity. Another benefit of at least some embodiments is improved user interface functionality that enables an entity to choose a communication mechanism that is more likely to result in a desired bidirectional communication being established. These improvements to computer functionality can improve the efficiency of electronic communications between entities and ultimately, improve the number and/or quality of connections on the connection network. These improvements can reduce low-quality communications which can, in turn, improve the overall bandwidth of the connection network.

Process Overview

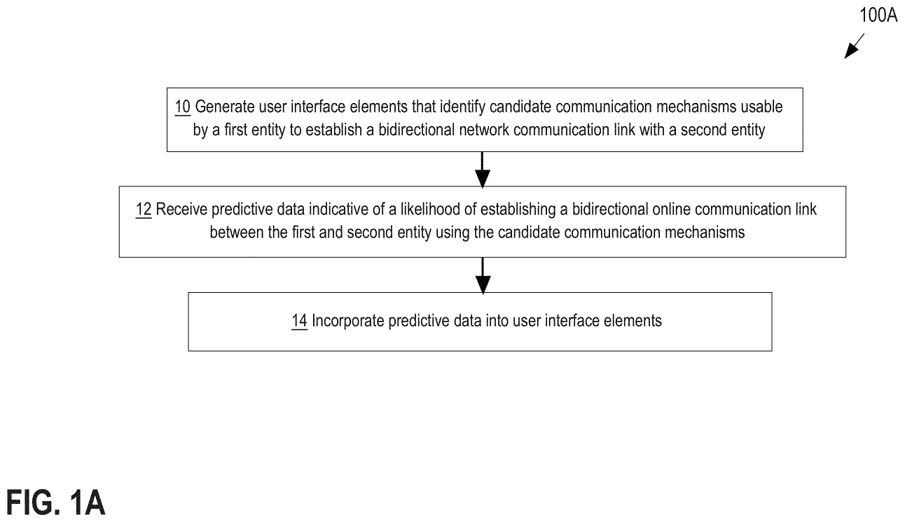

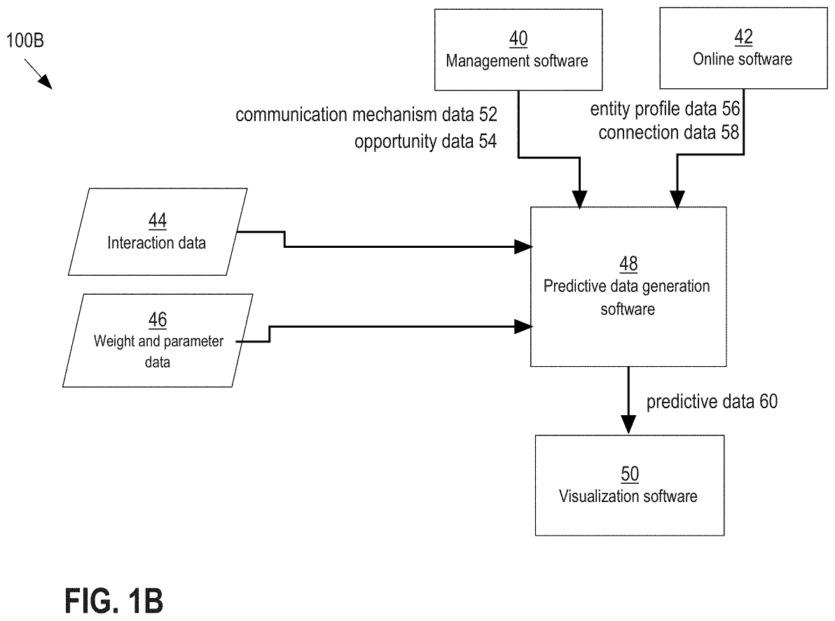

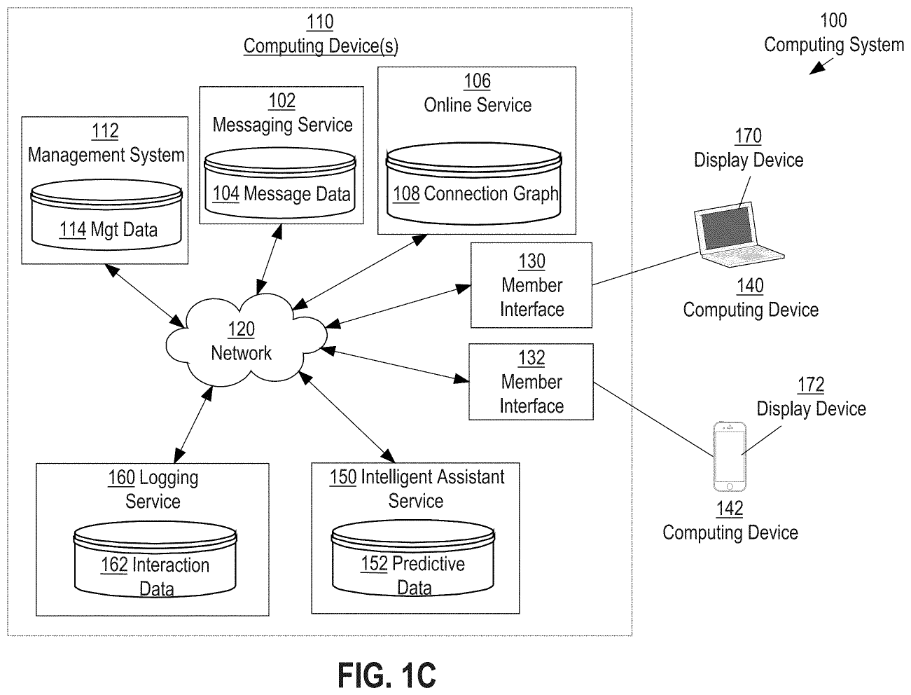

FIG. 1A is a flow diagram that depicts a process 100A that can be used by an online service or management system to incorporate predictive data into user interface elements that identify candidate communication mechanisms, in an embodiment. Process 100A may be performed by a single entity or program or by multiple entities or programs, including for example a browser plug-in and a remote server. The operations of the process as shown in FIG. 1A can be implemented using processor-executable instructions that are stored in computer memory. For purposes of providing a clear example, the operations of FIG. 1A are described as performed by computing device(s) 110, 140, which may be individually or collectively referred to as simply ‘computing system 100.’ In an embodiment, process 100A may be performed by a member interface 130, 132 communicating with a management system 112 or an online service 106, which components are described below with reference to FIG. 1C.

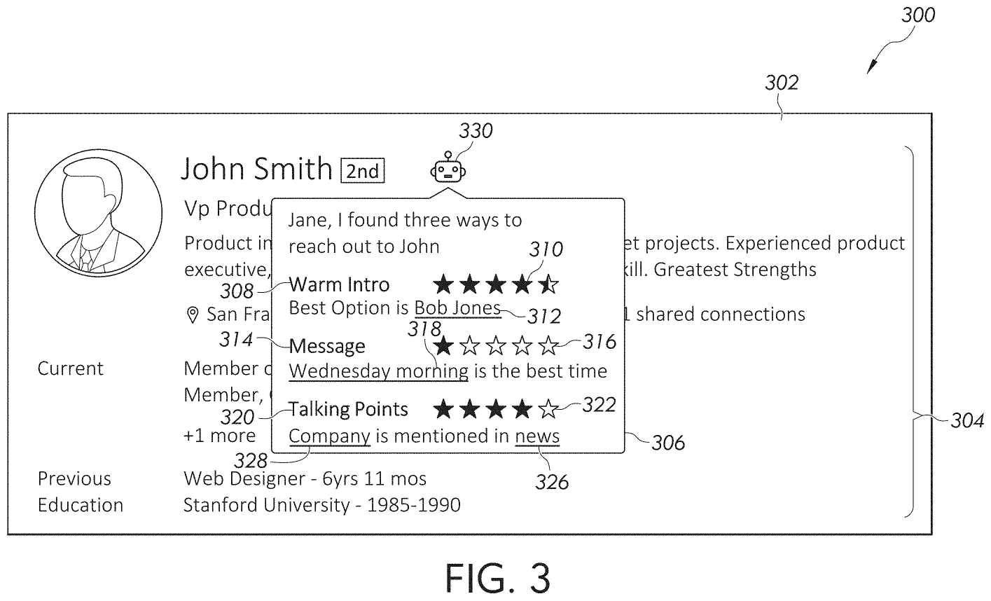

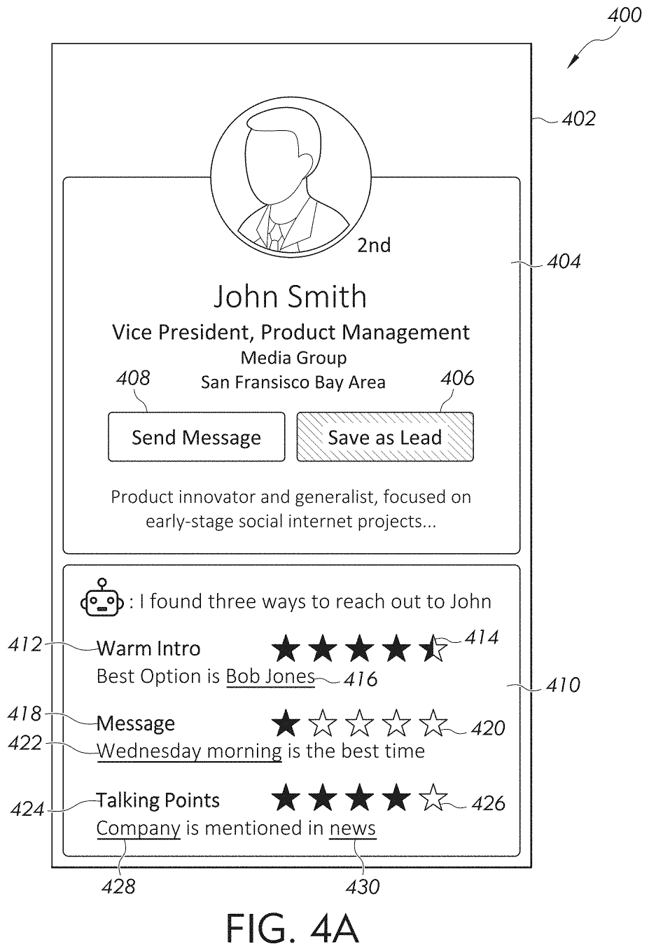

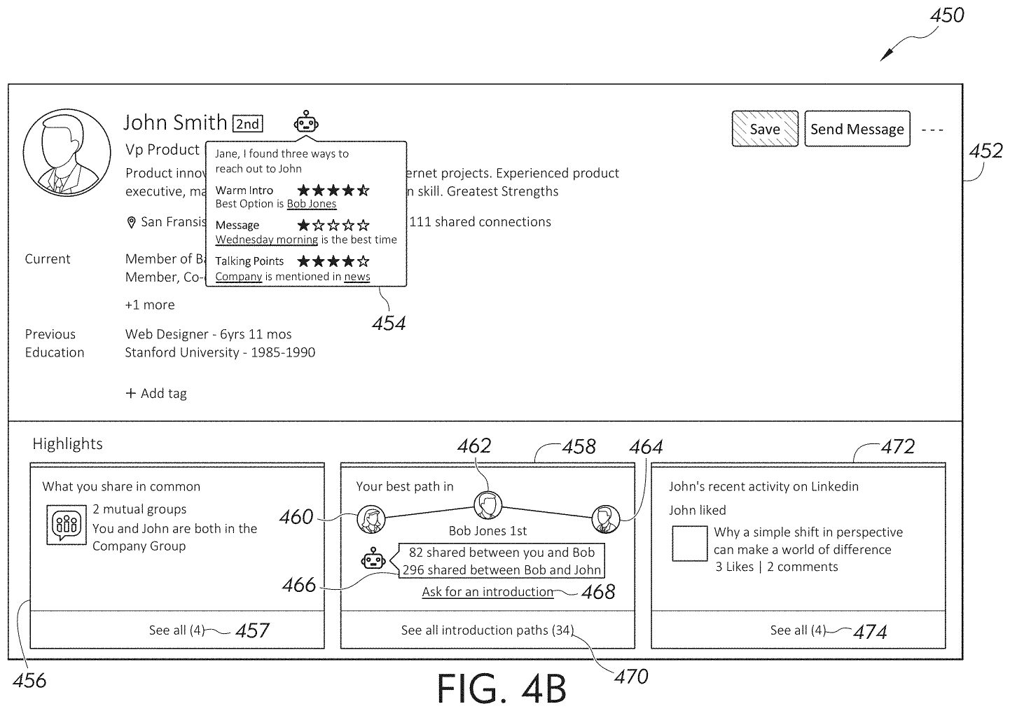

In operation 10, computing system 100 generates user interface elements that identify candidate communication mechanisms usable by a first entity to establish a bidirectional network communication link with a second entity. The term “user interface elements” may be used to refer to visual and/or non-visual user interface elements. For example, user interface elements include graphical elements, audio output, such as computer-synthesized voice and speech output, and/or haptic output, in some embodiments. Illustrative, non-limiting examples of user interface elements are shown in FIGS. 3, 4A, and 4B, described below. Illustrative, non-limiting examples of candidate communication mechanisms are electronic introductions by intermediate nodes and direct electronic messaging. An example of a supplemental communication mechanism is automatic news feed content extraction, where the news feed content can be incorporated into the other candidate communication mechanisms to further improve the chances of success.

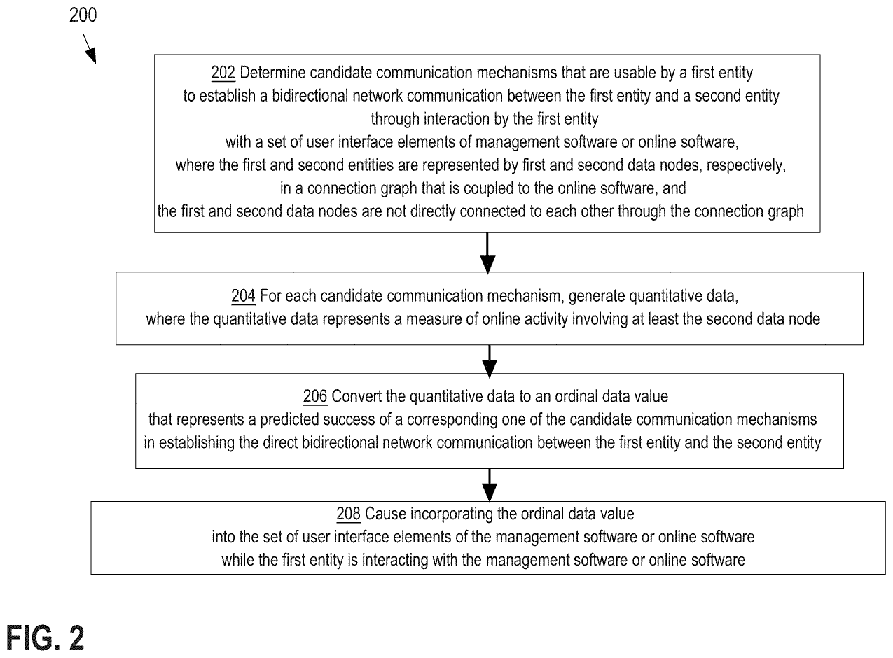

In operation 12, computing system 100 receives predictive data indicative of a likelihood of establishing a bidirectional online communication link between the first and second entity using the candidate communication mechanisms. In an embodiment, the predictive data includes the ordinal data values that are computed using quantitative data as described herein. In some implementations, the predictive data is not generated by the management system 112 or online service 106, but rather is computed by an intelligent assistant service 150 and is then supplied to management system 112 and/or online service 106 through a network 120, as described in more detail below. Additional details of specific steps for computing the predictive data for candidate communication mechanisms are described with reference to FIG. 2, below.

In operation 14, computing system 100 incorporates the predictive data generated in operation 12 into the user interface elements generated in operation 10. In an embodiment, the predictive data is incorporated into the user interface elements by generating star ratings graphical elements that represent the ordinal data values that are computed in operation 12 and aligning those ratings graphical elements with the user interface elements that identify the corresponding communication mechanisms, generated in operation 10. Illustrative, non-limiting examples of the described combination of user interface elements and ordinal data values are shown in FIGS. 3, 4A, and 4B, described below.

Example Arrangement of Software Components for Generating Predictive Data for Candidate Communication Mechanisms

FIG. 1B is a block diagram that depicts an example system 100B for generating predictive data for candidate communication mechanisms using a management system and an online service, in an embodiment. The software-based components of the system of FIG. 1B include management software 40, online software 42, predictive data generation software 48, visualization software 50, interaction data 44, and weight and parameter data 46.

Management software 40 is software that stores and manages contact information and transaction-related information about entities that may or may not be registered in online software 42. Such entities include individuals and companies, and can include sales prospects to which sales of one or more products or services are desired or intended to be made. An example of management software 40 is LINKEDIN SALES NAVIGATOR, alone or in combination with a database system (such as a customer relationship management or CRM database system).

Users of management software 40 may or may not be registered in the online software 42. In some embodiments, registered users of online software 42 are also, automatically, registered users of management software 40. In other embodiments, management software 40 includes a separate registration process. In those other embodiments, a portion of intelligent assistant service 150 creates and stores, in an electronic file or a mapping table, for example, a mapping that links the member registration data stored in online software 42 with the member registration data stored in management software 40, to facilitate the exchange of data between the two systems.

Online software 42 is software that is designed to provide an online networking service for entities, such as a professional networking service or an online social network service. An example of online software 42 is the online professional social network service known as LINKEDIN, provided by LinkedIn Corporation of Sunnyvale, Calif. Online software 42 generally enables traversal of an online connection network and viewing of entity profile data that is stored in association with corresponding data nodes of the connection network. In an embodiment, connection network data and associated entity profile data are stored in a connection graph 108, described below with reference to FIG. 1C.

Predictive data generation software 48 is logically interposed between management software 40 and online software 42. Predictive data generation software 48 receives communication mechanism data 52 and opportunity data 54 from management software 40. Communication mechanism data 52 identifies the communication mechanisms that are available through management software 40 for establishing bidirectional communications between entities on the connection network. In an embodiment, communication mechanism data 52 identifies at least two different types of communication mechanisms, including electronic introduction by intermediate node and direct electronic messaging, and at least one supplemental communication mechanism that includes entity news feed interaction rate and content links.

Opportunity data 54 identifies to prediction data generation software 48 candidate target entities with whom a particular entity using management software 40 may desire to establish bidirectional communication. As such, opportunity data 54 identifies both the first entities who seek to establish bidirectional communications with other entities, and one or more potential second entities. In an embodiment, the potential second entities are sales leads identified by, for example, other processes of management software 40. The potential second entities may be specific to a particular first entity or more general in nature. Through the mapping to entity profile data 56, the data nodes in the connection network provided by online software 42 that correspond to the potential second entities are also determined.

Online software 42 is software that is operated by an online networking service for its members, such as a professional networking service or an online social network service. End users become members of an online service 106 operating online software 42 through a registration process that includes establishing a user account identifier, password, and online profile. An example of an online service 106 operating online software 42 is the online professional social network service known as LINKEDIN, provided by LinkedIn Corporation of Sunnyvale, Calif.

Online software 42 supplies entity profile data 56 and connection data 58 to predictive data generation software 48. Entity profile data 56 identifies data nodes and profile data that correspond to opportunity data 54. Connection data 58 identifies connections between data nodes on the connection network. For example, connection data 58 is used to determine whether data nodes of first and second entities are directly connected on the connection network and to identify prospective intermediate nodes that may be used for an electronic introduction.

Predictive data generation software 48 is operably coupled to management software 40 and online software 42, such as through application programming interface(s) (APIs) and network 120, shown in FIG. 1C, described below. Predictive data generation software 48 receives communication mechanism data 52 and opportunity data 54 from management software 40 as a result of a data extraction and standardization process, which extracts the desired data and meta information from management software 40 and uses standardization rules to format and store the extracted data in an electronic file. The data extraction and standardization processes disclosed herein are implemented using computer code that is written in a programming language, such as Python. Communication mechanism data 52 and opportunity data 54 may be an electronic data file that includes text-based data labeled with semantic tags, in an embodiment.

Predictive data generation software 48 receives entity profile data 56 and connection data 58 from online software 42 as a result of another data extraction and standardization process, which extracts the desired data and meta information from online software 42 and uses standardization rules to format and store the extracted data in an electronic file. Electronic data files disclosed herein are created using JSON (JavaScript Object Notation), XML (Extensible Markup Language), or HTML (Hypertext Markup Language), in some embodiments.

Interaction data 44 includes data indicative of an entity's interactions with online software 42 and/or messaging service 102, described below with reference to FIG. 1C. Interaction data 44 may be collected by an automated logging service 160, described below with reference to FIG. 1C. Collection of interaction data 44 is done with the entity's permission or pursuant to a privacy policy, using cookies or other similar methods. Examples of interaction data 44 include an entity's search history data, including keywords used in online searches performed by the entity, view history data, including data indicative of entity profiles viewed by the member within online software 42, and message view and reply history data, including date/timestamp data.

Weight and parameter data 46 is data that specifies parameter values that are used in the determination of quantitative data to be used to compute ordinal data values and weight values that are used in the computation of ordinal data values. Weight and parameter data 46 is adjustable programmatically or by user input, and may be stored in or referenced by management data 114, connection graph 108, or predictive data 152. Examples of parameter values include threshold data values that control the number of common connections used to identify a candidate connector node or the number of message views or replies used to generate a message-related ordinal data value. For example, parameter values may be used to determine an amount of quantitative data used to compute ordinal data values or a time interval used to determine a relevant set of quantitative data that is extracted from, for example, connection data 58 and interaction data 44.

Weight data 46 is data that may be configured based on the particular type of ordinal data value and/or output data elements that are used in a particular implementation. Weight data is also used to adjust the relative importance of different quantitative data in the ordinal data value computations. For example, weight data can be adjusted so that common connections between an intermediate node and a first entity are given more importance than common connections between the intermediate node and a second entity, or vice versa. Weight data is adjustable programmatically or by user input, and may be stored in or referenced predictive data 152, in an embodiment. Examples of weight data are numerical values, such as positive or negative integers, ratios, or percentages.

Predictive data generation software 48 executes computer instructions that implement all or a portion of the processes shown in FIG. 1A, described above, and FIG. 2, described below, in an embodiment. Using communication mechanism data 52, opportunity data 54, entity profile data 56, and connection data 58 as inputs, predictive data generation software 48 executes the disclosed computational methods in accordance with the weight and parameter data 46 to produce predictive data 60. Predictive data 60 includes ordinal data values as disclosed herein. Predictive data generation software 48 transmits or otherwise makes available predictive data 60 to visualization software 50.

Visualization software 50 produces a visualization that incorporates at least the predictive data 60 into user interface elements generated by management software 40 or online software 42. Example visualizations are shown in FIGS. 3, 4A and 4B, described below. Visualization software 50 is implemented as a graphical user interface rendering tool and may be implemented as part of operating system software of a computing device. Visualization software 50 may be implemented within management software 40 or within online software 42 or within another software application (such as messaging software), or may be implemented as a separate module as shown in FIG. 1B.

Example Networked System Environment

In a connection network, a search query can be executed to identify nodes with which another node is or is not already connected. When the results of the search query are returned, the connection network may identify existing connection paths between a node that is the subject of the search and one or more of the nodes that are returned by the query. The connection network can establish a connection between two nodes in response to a request by one of the nodes and acceptance of the request by the other node.

A connection network as used herein may refer to a computer-implemented online system, such as a professional networking service or a social network application, which may be provided by, for example, a social network service. In a connection network, a node may refer to a computer-implemented representation of an entity, such as a person or an organization, that uses the connection network via a computing device. A node can be implemented, for example, as a data object or a record that is stored in a database. The node contains or is associated with stored data that identifies the node and the entity that the node represents. The stored data may include identifier data such as the entity name, and may contain other data associated with the entity, such as organizations with which the entity is affiliated, geographic locations, interests, and dates of connection.

A connection as used herein may refer to a computer-implemented logical relationship between two nodes on a connection network. The logical relationship can be formed based on mutual consent of the entities represented by the nodes, as evidenced by an exchange of electronic messages between the nodes. The connection may have associated attributes, such as affiliations or interests that the entities represented by the nodes have in common. “Logical” as used herein may refer to a connection that is made by execution of computer-implemented instructions manipulating a data structure, for example, as opposed to a physical or hard-wired connection. In other words, a logical connection may refer to a software abstraction of a physical connection.

A connection can be implemented, for example, by instantiating a data object or a record that is stored in a database. The connection contains or is associated with data that identifies the connected nodes (such as unique node identifiers), and may contain other data associated with the connection (or references to such data, implemented in software as, for example, pointers or hyperlinks), including the date that the connection was established and attributes that the connected nodes have in common.

A connection graph or connection graph data as used herein may refer to a computer-implemented representation of nodes and the connections that exist between the nodes in a connection network. Portions of a connection graph or connection graph data may be displayed in a graphical interface on a display device, alone or in combination with other elements of the graphical interface. An absence of connections between two nodes is indicated by an absence of connections (links) in a connection graph; for example, a lack of logical relationships linking node data for the two nodes in a database.

Software platforms can leverage the connection network to provide domain-specific functionality. For example, content distribution, recruiting, marketing, and sales platforms can access and query the connection network through application programming interfaces (APIs). Management system 112, messaging service 102, and intelligent assistant service 150 are examples of software-based systems and services that may obtain and leverage data from a connection network.

FIG. 1C is a block diagram that depicts an example computing system 100 arranged to operate a management system 112, an intelligent assistant service 150, member interfaces 130, 132, and to leverage information obtained from an online service 106, a messaging service 102, and a logging service 160, in an embodiment. Computing system 100 includes computing device(s) 110, computing devices 140, 142, and display devices 170, 172, which are communicatively coupled to an electronic communications network 120.

Implemented in the devices 110, 140, 142, 170, 172 using computer software, hardware, or software and hardware, are processor-executable instructions, data structures, and digital data, stored in memory, which cooperate to provide the computer-implemented functionality described herein. For ease of discussion, these computer-implemented components are represented schematically in FIG. 1C as messaging service 102, message data 104, online service 106, connection graph 108, member interface 130, member interface 132, intelligent assistant service 150, predictive data 152, logging service 160, interaction data 162.

“System” as used herein may refer to a single computer or network of computers and/or other devices. “Computing device” as used herein may refer to a computer or any other electronic device that is equipped with a processor. Although computing system 100 may be implemented with any number of messaging service 102, message data 104, online service 106, connection graph 108, member interface 130, member interface 132, intelligent assistant service 150, predictive data 152, logging service 160, interaction data 162, computing device(s) 110, display devices 170, 172 and computing devices 140, 142, respectively, in this disclosure, these elements may be referred to in the singular form for ease of discussion.

Messaging service 102, message data 104, online service 106, connection graph 108, member interface 130, member interface 132, intelligent assistant service 150, predictive data 152, logging service 160, interaction data 162 are shown as separate elements in FIG. 1C for ease of discussion but the illustration is not meant to imply that separation of these elements is required. The illustrated systems (or their functionality) and data stores may be divided over any number of physical systems, including a single physical computer system, and can communicate with each other in any appropriate manner.

Member interfaces 130,132 enable access to different portions of the functionality of computing system 100, by computing devices 140, 142. User interface elements and ordinal data values, as disclosed herein, for example those shown in FIGS. 3, 4A, 4B, are presented to entities via member interfaces 130, 132.

Portions of the illustrative messaging service 102, online service 106, management system 112, intelligent assistant service 150, and logging service 160 may be implemented as web-based software applications and hosted by a hosting service (not shown). For example, member interfaces 130, and portions of management system 112 and intelligent assistant service 150 may be implemented as client-side and server-side portions, respectively, of a social selling platform such as the SALES NAVIGATOR software, which is commercially available from LinkedIn Corporation of Sunnyvale, Calif. While member interface 132 and online service 106 may be implemented as client-side and server-side portions, respectively, of a connection network service such as the LINKEDIN software, which is commercially available from LinkedIn Corporation of Sunnyvale, Calif. In an embodiment, portions of each of member interface 130 and member interface 132 are implemented in a web browser that can execute on computing devices 140, 142, respectively.

In some embodiments, each of computing devices 140, 142 is a client-side computing device or set of cooperating computing devices, such as a smart phone, tablet computer, wearable or body-mounted device, smart appliance, laptop machine, or combination of any of such devices, and computing device 110 is a server-side computing device such as a server computer or network of server computers accessible by the Internet, for example in a public or private cloud. As illustrated in FIG. 1C, each of display devices 170, 172 is implemented in a computing device 140, 142, respectively, but may be implemented as a separate device or as part of another device, or as multiple networked display devices, in other implementations.

The example messaging service 102 creates, sends and receives electronic communications between entities represented by nodes of the online service 106. Portions of messaging service 102 may be implemented as a text messaging service such as SMS (Short Message Service) or MMS (Multimedia Messaging Service), or as a public or private electronic mail system, or as a messaging service that is tightly coupled with the online service 106 in that messages may only be sent to other nodes within the connection network (for example, the LINKEDIN INMAIL software, which is commercially available from LinkedIn Corporation of Sunnyvale, Calif.). The information maintained by messaging service 102, including the contents of messages transmitted over the network 120 by messaging service 102, is stored in message data 104, which may be implemented using an electronic file system or a table-based relational database or a hierarchical database, for example.

Online service 106 is a computer-implemented networking service for entities, such as a professional networking service or an online social network. Online service 106 contains nodes that represent the entities using the online service 106. Data associated with nodes and connections between nodes are represented using connection graph 108. Portions of connection graph 108 and/or associated data are stored in a data structure, such as a graph-based database system or a relational database system, in the context of online service 106, “node” may refer to a software abstraction of entity data, and need not be tied to any particular hardware or machine that is connected to network 120.

Some implementations of online service 106 allow entities (via users operating electronic devices) to register with online service 106 (thereby creating a node on online service 106), create entity data (for example, profile data), establish connections with other registered entities, and perform other actions, such as message other entities, post articles, view postings from other entities, comment on postings, “like” postings, endorse other entities or established connections, etc. An entity profile may include, for example, a name of the entity, a job title, a job industry, academic institutions attended, employment status, previous and current employers, skills, endorsements from other entities, contact information, address information.

Management system 112 is software that stores and manages transaction-related information about entities that may or may not be registered in the online service 106. Such entities include individuals and companies, and can include sales prospects to which sales of one or more products or services are desired or intended to be made. An example of management software 40 operated by management system 112 is LINKEDIN SALES NAVIGATOR, alone or in combination with a database system (such as a customer relationship management or CRM database system).

Message data 104, connection graph 108, management data 114, interaction data 162, and predictive data 152 can be searched by computing system 100 using a query language (such as the structured query language or SQL) to find information, such as entity information and content of interest, that may be relevant to a particular node or connection path on the online service 106.

Network 120 may be implemented on any medium or mechanism that provides for the exchange of data between the devices that are connected to the network. Examples of network 120 include, without limitation, a network such as a Local Area Network (LAN), Wide Area Network (WAN), Ethernet or the Internet, or one or more terrestrial, satellite or wireless links. Network 120 may include a combination of networks, such as a combination of wired and wireless networks, as needed to enable communications between the computing device(s) 110, 140, 142.

Computing devices 140, 142 operate member interfaces 130, 132 to establish logical connection(s) over network 120 with portions of intelligent assistant service 150 and may establish logical connections) over network 120 with messaging service 102, online service 106, logging service 160, and/or management system 112, either directly or via intelligent assistant service 150. Examples of views that may be displayed by member interfaces 130, 132 on display devices 170, 172 are shown in FIGS. 3, 4A, and 4B, described below. A view as used herein may refer to a window of a graphical user interface (GUI), or a portion of a window, such as a text display box, an image, a graphical element, or any combination of GUI elements.

Components of intelligent assistant service 150 cooperate with management system 112 and/or online service 106 to determine and control the data that is displayed on display devices 170, 172 via member interfaces 130, 132. Computer code executable by intelligent assistant service 150 generates predictive data relating to candidate communication mechanisms as disclosed herein. One implementation of processes executed by intelligent assistant service 150 is described in more detail below with reference to FIG. 2.

Example Computations of Predictive Data

FIG. 2 is a flow diagram that depicts a process 200 for computing predictive data for candidate communication mechanisms, in an embodiment. Process 200 may be performed by a single entity or program or by multiple entities or programs, including for example a browser plug-in and a remote server. The operations of the process as shown in FIG. 2 can be implemented using processor-executable instructions that are stored in computer memory. For purposes of providing a clear example, the operations of FIG. 2 are described as performed by computing device(s) 110, 140, which may be individually or collectively referred to as simply ‘computing system 100.’

In operation 202, computing system 100 determines candidate communication mechanisms that are usable by a first entity to establish a bidirectional network communication between the first entity and a second entity through interaction by the first entity with a set of user interface elements of management software or online software, where the first and second entities are represented by first and second data nodes, respectively, in a connection graph that is coupled to the online software, and the first and second data nodes are not directly connected to each other through the connection graph.

To determine the candidate communication mechanisms that are available to the first entity through the management software or online software, operation 202 obtains communication mechanism data from management software and/or online software. The available candidate communication mechanisms may vary depending on the identity, policies or preferences of the first and second entities. For example, some entities may enable direct messaging while others may not, and some entities may limit or restrict electronic introductions made through intermediate nodes.

For purposes of this example, generation of predictive data, specifically, ratings data, is discussed in the context of three candidate communication mechanisms: electronic introductions through intermediate nodes, also called warm intro rating, direct messaging rating, and talking point rating. For the warm intro rating, computing system 100 predicts a likelihood with which the second entity may respond to a warm intro and identifies a best option intermediate node.

For the direct messaging rating, computing system 100 predicts a likelihood with which the second entity may respond to a direct message received from the first entity and identifies a recommended best day/time for the first entity to send a message to the second entity. For the talking points rating, computing system 100 predicts the second entity's level of engagement with a news feed and provides a hyperlink to one or more news feed items that the first entity may review prior to engaging in either the warm intro option or the direct messaging option. It should be understood, however, that this disclosure is not limited to the described implementations and the processes for computing and presenting predictive data can be readily applied and adapted to other types of communication mechanisms.

In some embodiments, operation 202 is initiated in response to a trigger event. Examples of trigger events that may cause computing system 100 to initiate operation 202 include active and/or passive interactions. An example of detection of an active interaction is a first entity user interface device such as a graphical pointer or cursor clicking (or hovering over) an intelligent assistant icon on a user interface screen. An example of detection of a passive interaction is the first entity's device having displayed a particular second entity's profile page for more than a threshold period of time, for example x seconds, where x is a positive numerical value. Other types of interactions can trigger operation 202, such as executing a search query on the second entity's name or hack and forth mouse movements between buttons that activate two different communication mechanisms.

In operation 204, the quantitative data needed to compute the predictive data for each of the candidate communication mechanisms identified in operation 202 is generated. In each case, the quantitative data represents a measure of online activity involving at least the second data node. For the warm intro option, the quantitative data measures the relative strength of common connections between the first and second entities. For the direct messaging option, the quantitative data measures an overall message response rate of the second entity. For the talking point option, the quantitative data measures the second entity's relative engagement with the news feed in comparison to other users of the news feed portion of the online service. In some embodiments, the quantitative data produced for the talking point option measures the second entity's level of engagement with particular content items in the news feed, and ranks the news feed content items according to the second entity's level of engagement with the content items. For example, the talking point quantitative data ranks content items that the second entity has shared or commented on more highly than content items that the second entity has only viewed, in an embodiment. Each of these options is described in more detail below.

Warm Intro Rating

To compute the quantitative data for the warm intro rating, computing system 100 identifies a number N of common connections (which may be referred to as common data nodes) between first and second entities determined by operation 202, for example a requester X and a target Y. Computing system 100 ranks each common connection Z in requester X's network based on connection strength of Z to X, where connection strength is determined based on the number of shared connections between X and Z. This rank is represented as percentile A (for example, connection Z is ranked 5% in requester X's network), where 5% means that Z is ranked in the top 5% in terms of the number of shared connections in X's network. For example, if X has 100 connections, X and Z have N shared connections, then 100 minus 5=95 of X's connections have less than N shared connections with X.

Computing system 100 also ranks each common connection Z in target Y's network based on connection strength of Z to Y, where connection strength is determined based on the number of shared connections between Y and Z. This rank is represented as percentile B (for example, connection Z is ranked 13% in target Y's network), where 13% means that Z is ranked in the top 13% in terms of the number of shared connections in Y's network. For example, if Y has 100 connections, Y and Z have N shared connections, then 100 minus 13=87 of Y's connections have less than N shared connections with Y. Thus, for the warm intro rating, the output of operation 204 is a pair of percentile ranks, one for Z and X (Zₓ), and one for Z and Y (Z_{y}), in an embodiment. In another embodiment, Zₓ and Z_{y} are combined (for example, added together) to produce an overall score (Z_{x+y}).

Direct Messaging Rating

For the direct message rating, computing system 100 computes the overall message response rate for the target entity using recent historical interaction data 162, which is automatically collected by logging service 160. The time interval over which interaction data 162 is collected and used to compute the response rate is variable depending on the requirements of a particular implementation of the system. The message response rate is computed as a simple ratio of: (messages responded to)/(total number of messages), in an embodiment. In other embodiments, the set of messages used as the basis for computing the message response rate is filtered to include only “cold call” messages and exclude messages received by the target entity from entities with whom the target entity already has a strong connection or a connection of any strength. Thus, in some embodiments, the message response rate is configured to represent the target entity's historical behavior with respect to messages received from entities with whom the target entity is not connected.

In some embodiments, similar computations are done for other entities that use the direct messaging service, for example, a set of peers or all members of the online service. Then, Y's overall response rate is ranked in comparison to the scores computed similarly for these other entities, resulting in Y's response rate being converted to a percentile ranking M. The message response rate or percentile ranking is converted to an ordinal data value as described below.

In some embodiments, operation 204 also computationally determines recommended dates and times for requester X to send a message to target Y. In an embodiment, the predicted best time to send such a message is computed based on three criteria:

Requester X's sent day D1 (e.g., weekday) with highest response rate;

Target Y's activity level (overall response rate, computed as above) on the day D1 (weekday);

Time of the day (e.g., early morning, morning, noon, afternoon, night, late night) that corresponds to target Y's highest activity level.

Talking Points Rating

For the talking points option, computing system 100 obtains, from news feed activity tracking data logged by logging service 160, all of target Y's feed actions during a specified time interval, sorts the list of feed actions by certain categories (View, Expand, Like, Share, Comment) and give each action category a different weight. For comparison, similar computations are done for other entities that use the news feed service, for example, a set of peers or all members of the online service).

Computing service 100 then groups the scores by entity, so that all the scores for target Y across the different the feed action categories are grouped together. Computing service 100 then sums target Y's scores across all of the feed action categories, resulting in an overall talking points score. Computing system 100 then ranks the score relative to the talking points scores computed similarly for these other entities, resulting in Y's scores being converted to a percentile T.

In operation 206, computing system 100 converts the quantitative data generated in operation 204 for each candidate communication mechanism to an ordinal data value that represents a predicted success of a corresponding one of the candidate communication mechanisms in establishing the direct bidirectional network communication between the first entity and the second entity. That is, if operation 204 computes quantitative data for three different candidate communication mechanisms, then operation 206 computes corresponding ordinal data values for each of the three candidate communication mechanisms. To do this, computing system 100 normalizes the quantitative data generated in operation 204. For example, if the desired ratings scale is 0 to 5 stars, the quantitative data may be converted to a percentile rank and then multiplied by 5.

More specifically, for the warm intro rating, in an embodiment, the quantitative data (the percentile data A and B computed in operation 204) is converted to an ordinal data value by computing a weighted average of A and B, using the equation ODV=[W1*(1−A)+W2*(1−B)]/2*P1, where W1 and W2 are weight values that are adjustable to vary the importance of A or B in the final rating value, and P1 is parameter data that corresponds to the ratings scale (for example, P1=5 for a 5 star rating scale).

For the messaging rating, the overall message response rate or percentile M, as the case may be, is normalized to a ratings scale, for example 0 to 5, which produces the final ordinal data value for the direct messaging communication mechanism.

For the talking points rating, in an embodiment, the quantitative data (percentile T) is normalized to a ratings scale, for example 0 to 5, which produces the final ordinal data value for the talking points communication mechanism.

In operation 208, computing system 100 causes incorporating the ordinal data value into the set of user interface elements of the management software or online software while the first entity is interacting with the management software or online software. In embodiment, computing system 100 causes the ordinal data value computed in operation 206 to be sent to visualization software 50, which transforms the ordinal data value to a set of graphical elements which are then displayed in alignment with data identifying the corresponding candidate communication mechanism. Examples of the resulting output are shown in FIGS. 3, 4A, 4B, described below.

Use Case: Connection Network

As a specific example, FIG. 3 is a screen capture 300 that includes user interface elements that may be displayed by member interface 130, 132 when a first entity views a second entity's profile page 302 through an online service such as LINKEDIN and hovers over or taps an intelligent assistant icon 330. The profile page 302 includes a set of profile data user interface elements 304. User interface elements 304 include entity name, title, a digital image, location, current position, job history, and education data. User interface elements 304 also include a “2^{nd}” indicator which indicates that the first entity is not directly connected to the second entity on the connection network.

Activation of icon 330 causes computing system 100 to generate a popup set of user interface elements 306. User interface elements 306 include candidate communication mechanism identifiers 308, 314, 320 and corresponding predictive user interface elements 310, 316, 322 displayed in alignment with the identifiers 308, 314, 320. The predictive user interface elements 310, 316, 322 are representative of ordinal data values that are computed based on quantitative data as disclosed herein.

User interface elements 306 also include hyperlinks 312, 318, 326, 328. Hyperlink 312 highlights the name of an entity that is associated with the best option intermediate data node that is computationally determined as described herein. Activation of hyperlink 312 causes computing system 100 to display the entity profile data associated with the best option intermediate data node (here, Bob Jones).

Similarly, hyperlink 318 highlights the day of the week and time that has been computationally determined to be the time at which the second entity (here, John Smith) is most likely to respond to a direct message. Activation of hyperlink 318 causes computing system 100 to display, for example, a create a new message window or a calendar appointment window or a reminder task window, through which the first entity viewing the John Smith profile data can proceed to create an electronic message addressed to John Smith or set a reminder to do so at the computationally determined best option day and time.

Hyperlinks 326, 328 highlight the second entity's employer (Company 328) and relevant recent news items which the second entity may already have viewed, shared, liked, or commented on. Activation of hyperlink 328 initiates a keyword search of the news feed database for content items that mention Company, without regard to the date of the content item. Activation of hyperlink 326 initiates a keyword search of the news feed database for recent news articles in which Company is mentioned, where recency is configurable by adjusting a parameter value (for example, recent may include content items having a date/timestamp within the last 24 hours or within the last week). While not specifically shown in FIG. 3, in some embodiments, computing system 100 displays a summary of content items with which the second entity engaged (e.g., liked/commented/shared/authored), in accordance with all applicable privacy rules, regulations, policies and user preferences. The summary display enables the first entity to review multiple candidate content items and choose one or more of the content items to incorporate into talking points of a direct message or via the warm intro option.

Use Case: Lead Generation

As another specific example, FIGS. 4A and 4B are screen captures 400, 450 of small form factor (e.g., mobile device) and larger form factor (e.g., desktop/laptop/tablet) versions of display screens that include user interface elements that may be displayed by member interface 130, 132 when a first entity views a second entity's profile page 404, 452 through management software such as LINKEDIN SALES NAVIGATOR.

In FIG. 4A, mobile device display screen 402 includes both an entity profile section 404 and a communication mechanism rating section 410. In this example, section 410 is displayed automatically when computing system 100 detects that the first entity has been viewing the profile section 404 for greater than a threshold length of time without taking any action, even though profile section 404 includes action options 408 (send message) and 406 (save as lead). For example, if neither of buttons 406, 408 is activated within the threshold time interval, section 410 is automatically displayed. (Alternatively, section 410 is displayed automatically with section 404 when the first entity requests the second entity's profile.) In section 410, the communication mechanism identifier elements 412, 418, 424; predictive data elements 414, 420, 426, and hyperlinks 416, 422, 428, 430 all function similarly to the corresponding elements shown in FIG. 3, described above.

In FIG. 4B, a similar display screen 452 is shown, including a communication mechanism rating popup section 454. Section 454 contains similar elements as section 410 of FIG. 4A, which function in a similar manner to the corresponding elements of FIG. 4A. Additionally, display screen 452 includes detail boxes 456, 458, 472, each of which provides more detail relating to one or more of the candidate communication mechanisms shown in section 454. Detail box 456 displays common group information. Detail box 472 displays summary information for a content item extracted from the news feed, where the selected content item corresponds to the talking point data shown in Section 454. For example, detail box 472 shows summary information for a news article that the second entity, John Smith, recently liked.

Detail box 458 provides a visual illustration of the warm intro best option data that includes digital images of the first entity 460, second entity 464, and best option intermediate entity 462. Detail box 458 also displays explanatory information that is provided to assist the first entity in understanding the computational process undertaken by computing system 100 to determine the best option intermediate entity, without disclosing highly sensitive data. This explanatory information is shown in box 466 and includes the counts of common connections that were used by computing system 100 to generate the warm intro ratings data shown in section 454. In some embodiments, the detail information shown in box 466 is only displayed if an intelligent assistant icon is activated and all required data privacy and security rules have been satisfied. Detail box 458 also includes hyperlink 468, which when activated displays a direct message box pre-populated with the warm option best intro intermediate entity's contact information. Further detailed information can be reviewed by the first entity through interactive elements 457, 470, 474, subject to any applicable data access constraints.

Display screens such as those shown in FIGS. 3, 4A, and 4B are designed using a graphical user interface software development tool. The particular GUI designs shown in FIGS. 3, 4A, and 4B are illustrative of some embodiments, and this disclosure is not limited to those designs.

Implementation Example—Hardware Overview

According to one embodiment, the techniques described herein are implemented by one or more computing devices. For example, portions of the disclosed technologies may be at least temporarily implemented on a network including a combination of one or more server computers and/or other computing devices. The computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, or FPGAs with custom programming to accomplish the described techniques.

The computing devices may be server computers, personal computers, or a network of server computers and/or personal computers. Illustrative examples of computers are desktop computer systems, portable computer systems, handheld devices, mobile computing devices, wearable devices, body mounted or implantable devices, smart phones, smart appliances, networking devices, autonomous or semi-autonomous devices such as robots or unmanned ground or aerial vehicles, or any other electronic device that incorporates hard-wired and/or program logic to implement the described techniques.

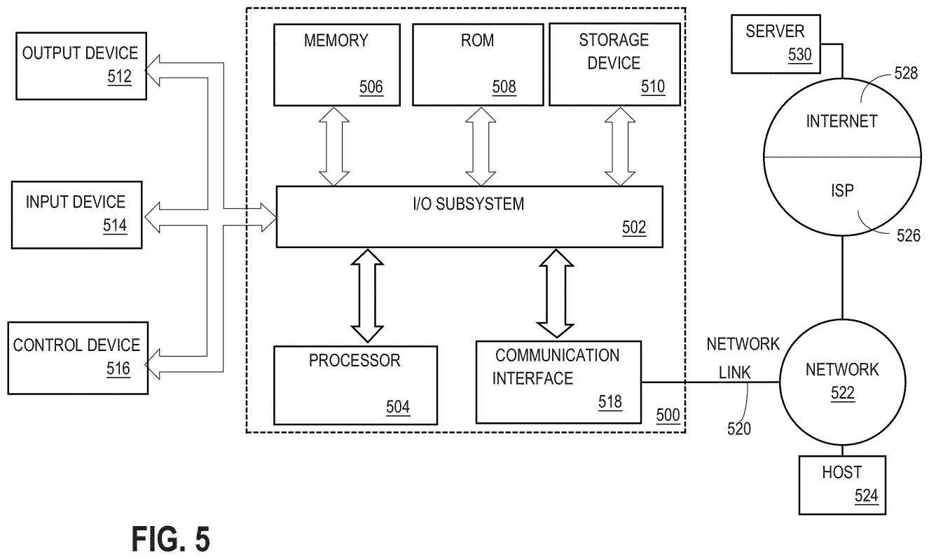

For example, FIG. 5 is a block diagram that illustrates a computer system 500 upon which an embodiment of the present invention may be implemented. Components of the computer system 500, including instructions for implementing the disclosed technologies in hardware, software, or a combination of hardware and software, are represented schematically in the drawings, for example as boxes and circles.

Computer system 500 includes an input/output (I/O) subsystem 502 which may include a bus and/or other communication mechanism(s) for communicating information and/or instructions between the components of the computer system 500 over electronic signal paths. The I/O subsystem may include an I/O controller, a memory controller and one or more I/O ports. The electronic signal paths are represented schematically in the drawings, for example as lines, unidirectional arrows, or bidirectional arrows.

One or more hardware processors 504 are coupled with I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor.

Computer system 500 also includes a memory 506 such as a main memory, which is coupled to I/O subsystem 502 for storing information and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, render computer system 500 into a special-purpose machine that is customized to perform the operations specified in the instructions.

Computer system 500 further includes a non-volatile memory such as read only memory (ROM) 508 or other static storage device coupled to I/O subsystem 502 for storing static information and instructions for processor 504. The ROM 508 may include various forms of programmable ROM (PROM) such as erasable PROM (EPROM) or electrically erasable PROM (EEPROM). A persistent storage device 510 may include various forms of non-volatile RAM (NVRAM), such as flash memory, or solid-state storage, magnetic disk or optical disk, and may be coupled to I/O subsystem 502 for storing information and instructions.

Computer system 500 may be coupled via I/O subsystem 502 to one or more output devices 512 such as a display device. Display 512 may be embodied as, for example, a touch screen display or a light-emitting diode (LED) display or a liquid crystal display (LCD) for displaying information, such as to a computer user. Computer system 500 may include other type(s) of output devices, such as speakers, LED indicators and haptic devices, alternatively or in addition to a display device.

One or more input devices 514 is coupled to I/O subsystem 502 for communicating signals, information and command selections to processor 504. Types of input devices 514 include touch screens, microphones, still and video digital cameras, alphanumeric and other keys, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be implemented as a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

Computer system 500 may implement the techniques described herein using customized hard-wired logic, one or more ASICs or FPGAs, firmware and/or program logic which in combination with the computer system causes or programs computer system 500 to operate as a special-purpose machine. According to one embodiment, the techniques herein are performed by computer system 500 in response to processor 504 executing one or more sequences of one or more instructions contained in memory 506. Such instructions may be read into memory 506 from another storage medium, such as storage device 510. Execution of the sequences of instructions contained in memory 506 causes processor 504 to perform the process steps described herein. In alternative embodiments, hard-wired circuitry may be used in place of or in combination with software instructions.

The term “storage media” as used in this disclosure refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to i/O subsystem 502 such as place the data on a bus. I/O subsystem 502 carries the data to memory 506, from which processor 504 retrieves and executes the instructions. The instructions received by memory 506 may optionally be stored on storage device 510 either before or after execution by processor 504.

Computer system 500 also includes a communication interface 518 coupled to bus 502. Communication interface 518 provides a two-way data communication coupling to network link(s) 520 that are directly or indirectly connected to one or more communication networks, such as a local network 522 or a public or private cloud on the Internet. For example, communication interface 518 may be an integrated-services digital network (ISDN) card, cable modem, satellite modem, or a modem to provide a data communication connection to a corresponding type of communications line, for example a coaxial cable or a fiber-optic line or a telephone line. As another example, communication interface 518 may include a local area network (LAN) card to provide a data communication connection to a compatible LAN. Wireless links may also be implemented. In any such implementation, communication interface 518 sends and receives electrical, electromagnetic or optical signals over signal paths that carry digital data streams representing various types of information.

Network link 520 typically provides electrical, electromagnetic, or optical data communication directly or through one or more networks to other data devices, using, for example, cellular, Wi-Fi, or BLUETOOTH technology. For example, network link 520 may provide a connection through a local network 522 to a host computer 524 or to other computing devices, such as personal computing devices or Internet of Things (IoT) devices and/or data equipment operated by an Internet Service Provider (ISP) 526. ISP 526 provides data communication services through the world-wide packet data communication network commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

### ADDITIONAL EXAMPLES

Illustrative examples of the technologies disclosed herein are provided below. An embodiment of the technologies may include any of the examples described below.

In an example 1, a method includes: in response to an interaction of a first entity with a set of software-based user interface elements, determining candidate communication mechanisms usable by the first entity to establish a bidirectional network communication between the first entity and a second entity, where the first entity and the second entity are represented by first and second data nodes, respectively, in a connection graph that is coupled to online software, where the first and second data nodes are not directly connected to each other through the connection graph; generating quantitative data that represents a measure of activity involving at least the second data node and the online software; converting the quantitative data to an ordinal data value that represents a predicted success of a corresponding one of the candidate communication mechanisms in establishing the bidirectional network communication between the first entity and the second entity; causing incorporating the ordinal data value into the set of user interface elements while the first entity is interacting with management software or the online software; where the method is performed by one or more computing devices.

An example 2 includes the subject matter of example 1, where incorporating the ordinal data value into the set of user interface elements includes representing the ordinal data value as a star rating. An example 3 includes the subject matter of example 1 or example 2, where the incorporating of the ordinal data value into the set of user interface elements is to improve a likelihood of the bidirectional network communication with the second entity being established by the first entity using one of the candidate communication mechanisms.

An example 4 includes the subject matter of any of examples 1-3, and includes computing the quantitative data by: counting common data nodes, where a common data node is connected to both the first data node and the second data node in the connection graph; and for each common data node, computing a first connection strength value and a second connection strength value, where the first connection strength value is computed by counting data nodes of the connection graph that are connected to both the first data node and the common data node, the second connection strength value is computed by counting data nodes of the connection graph that are connected to both the second data node and the common data node.

An example 5 includes the subject matter of example 4, where converting the quantitative data to the ordinal data value includes: for each common data node, computing a weighted average of the first connection strength value and the second connection strength value; ranking the common data nodes based on the weighted average; selecting, as a best option data node, a common data node, based on the ranking; and for the best option data node, multiplying the weighted average by a parameter value to obtain the ordinal data value. An example 6 includes the subject matter of example 5, including incorporating entity data associated with the best option data node into the set of user interface elements.

An example 7 includes the subject matter of any of examples 1-6, and includes computing the quantitative data by: computing an interaction rate based on second entity interaction data obtained from a logging service that logs electronic interactions of entities using the online software over a time interval, where the second entity interaction data relates to electronic interactions of the second entity with (i) an online news feed or (ii) a set of electronic messages sent to or received from other entities that use the online software or (iii) a combination of (i) and (ii). An example 8 includes the subject matter of example 7, including multiplying the interaction rate by a parameter value to obtain the ordinal data value. An example 9 includes the subject matter of example 7, including incorporating date/time data associated with the interaction rate into the set of user interface elements. An example 10 includes the subject matter of example 7, including incorporating talking point data into the set of user interface elements, where the talking point data is determined based on a grouping of second entity interaction data that corresponds to electronic interactions of the second entity with an online news feed.

In an example 11, a computer program product includes: one or more non-transitory computer-readable storage media including instructions which, when executed by one or more processors, cause the one or more processors to perform operations including: in response to an interaction of a first entity with a set of software-based user interface elements, determining candidate communication mechanisms usable by the first entity to establish a bidirectional network communication between the first entity and a second entity, where the first entity and the second entity are represented by first and second data nodes, respectively, in a connection graph that is coupled to online software, where the first and second data nodes are not directly connected to each other through the connection graph; generating quantitative data that represents a measure of activity involving at least the second data node and the online software; converting the quantitative data to an ordinal data value that represents a predicted success of a corresponding one of the candidate communication mechanisms in establishing the bidirectional network communication between the first entity and the second entity; causing incorporating the ordinal data value into the set of user interface elements while the first entity is interacting with management software or the online software.

An example 12 includes the subject matter of example 11, where incorporating the ordinal data value into the set of user interface elements includes representing the ordinal data value as a star rating. An example 13 includes the subject matter of example 11 or example 12, where the incorporating of the ordinal data value into the set of user interface elements is to improve a likelihood of the bidirectional network communication with the second entity being established by the first entity using one of the candidate communication mechanisms.

An example 14 includes the subject matter of any of examples 11-13, where the instructions, when executed by the one or more processors, cause computing the quantitative data by: counting common data nodes, where a common data node is connected to both the first data node and the second data node in the connection graph; and for each common data node, computing a first connection strength value and a second connection strength value, where the first connection strength value is computed by counting data nodes of the connection graph that are connected to both the first data node and the common data node, the second connection strength value is computed by counting data nodes of the connection graph that are connected to both the second data node and the common data node.

An example 15 includes the subject matter of example 14, where converting the quantitative data to the ordinal data value includes: for each common data node, computing a weighted average of the first connection strength value and the second connection strength value; ranking the common data nodes based on the weighted average; selecting, as a best option data node, a common data node, based on the ranking; and for the best option data node, multiplying the weighted average by a parameter value to obtain the ordinal data value. An example 16 includes the subject matter of example 15, where the instructions, when executed by the one or more processors, cause incorporating entity data associated with the best option data node into the set of user interface elements.

An example 17 includes the subject matter of any of examples 11-16, where the instructions, when executed by the one or more processors, cause computing the quantitative data by: computing an interaction rate based on second entity interaction data obtained from a logging service that logs electronic interactions of entities using the online software over a time interval, where the second entity interaction data relates to electronic interactions of the second entity with (i) an online news feed or (ii) a set of electronic messages sent to or received from other entities that use the online software or (iii) a combination of (i) and (ii). An example 18 includes the subject matter of example 17, where the instructions, when executed by the one or more processors, cause multiplying the interaction rate by a parameter value to obtain the ordinal data value. An example 19 includes the subject matter of example 17, where the instructions, when executed by the one or more processors, cause incorporating date/time data associated with the interaction rate into the set of user interface elements. An example 20 includes the subject matter of example 17, where the instructions, when executed by the one or more processors, cause incorporating talking point data into the set of user interface elements, where the talking point data is determined based on a grouping of second entity interaction data that corresponds to electronic interactions of the second entity with an online news feed.

General Considerations

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used in this disclosure the terms “include” and “comprise” (and variations of those terms, such as “including,” “includes,” “comprising,” “comprises,” “comprised” and the like) are intended to be inclusive and are not intended to exclude further features, components, integers or steps.

References in this document to “an embodiment,” etc., indicate that the embodiment described or illustrated may include a particular feature, structure, or characteristic, but every embodiment may not necessarily include the particular feature, structure, or characteristic. Such phrases are not necessarily referring to the same embodiment. Further, when a particular feature, structure, or characteristic is described or illustrated in connection with an embodiment, it is believed to be within the knowledge of one skilled in the art to effect such feature, structure, or characteristic in connection with other embodiments whether or not explicitly indicated.

Various features of the disclosure have been described using process steps. The functionality/processing of a given process step could potentially be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features and components mentioned or evident from the text or drawings. These different combinations constitute various alternative aspects of the embodiments.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
in response to an interaction of a first entity with a set of software-based user interface elements, determining candidate communication mechanisms usable by the first entity to establish a bidirectional network communication between the first entity and a second entity,
wherein the first entity and the second entity are represented by first and second data nodes, respectively, in a connection graph that is coupled to online software,
wherein the first and second data nodes are not directly connected to each other through the connection graph;
generating quantitative data that represents a measure of activity involving at least the second data node and the online software;
converting the quantitative data to an ordinal data value that represents a predicted success of a corresponding one of the candidate communication mechanisms in establishing the bidirectional network communication between the first entity and the second entity;
causing incorporating the ordinal data value into the set of user interface elements while the first entity is interacting with management software or the online software;
wherein the method is performed by one or more computing devices.

2. The method of claim 1, wherein incorporating the ordinal data value into the set of user interface elements comprises representing the ordinal data value as a star rating.

3. The method of claim 1, wherein the incorporating of the ordinal data value into the set of user interface elements is to improve a likelihood of the bidirectional network communication with the second entity being established by the first entity using one of the candidate communication mechanisms.

4. The method of claim 1, comprising computing the quantitative data by:
counting common data nodes, wherein a common data node is connected to both the first data node and the second data node in the connection graph; and
for each common data node, computing a first connection strength value and a second connection strength value, wherein the first connection strength value is computed by counting data nodes of the connection graph that are connected to both the first data node and the common data node, the second connection strength value is computed by counting data nodes of the connection graph that are connected to both the second data node and the common data node.

5. The method of claim 4, wherein converting the quantitative data to the ordinal data value comprises:
for each common data node, computing a weighted average of the first connection strength value and the second connection strength value;
ranking the common data nodes based on the weighted average;
selecting, as a best option data node, a common data node, based on the ranking; and
for the best option data node, multiplying the weighted average by a parameter value to obtain the ordinal data value.

6. The method of claim 5, comprising incorporating entity data associated with the best option data node into the set of user interface elements.

7. The method of claim 1, comprising computing the quantitative data by:
computing an interaction rate based on second entity interaction data obtained from a logging service that logs electronic interactions of entities using the online software over a time interval,
wherein the second entity interaction data relates to electronic interactions of the second entity with (i) an online news feed or (ii) a set of electronic messages sent to or received from other entities that use the online software or (iii) a combination of (i) and (ii).

8. The method of claim 7, comprising multiplying the interaction rate by a parameter value to obtain the ordinal data value.

9. The method of claim 7, comprising incorporating date/time data associated with the interaction rate into the set of user interface elements.

10. The method of claim 7, comprising incorporating talking point data into the set of user interface elements, wherein the talking point data is determined based on a grouping of second entity interaction data that corresponds to electronic interactions of the second entity with an online news feed.

11. A computer program product comprising:
one or more non-transitory computer-readable storage media comprising instructions which, when executed by one or more processors, cause the one or more processors to perform operations comprising:
in response to an interaction of a first entity with a set of software-based user interface elements, determining candidate communication mechanisms usable by the first entity to establish a bidirectional network communication between the first entity and a second entity,
wherein the first entity and the second entity are represented by first and second data nodes, respectively, in a connection graph that is coupled to online software,
wherein the first and second data nodes are not directly connected to each other through the connection graph;
generating quantitative data that represents a measure of activity involving at least the second data node and the online software;
converting the quantitative data to an ordinal data value that represents a predicted success of a corresponding one of the candidate communication mechanisms in establishing the bidirectional network communication between the first entity and the second entity;
causing incorporating the ordinal data value into the set of user interface elements while the first entity is interacting with management software or the online software.

12. The computer program product of claim 11, wherein incorporating the ordinal data value into the set of user interface elements comprises representing the ordinal data value as a star rating.

13. The computer program product of claim 11, wherein the incorporating of the ordinal data value into the set of user interface elements is to improve a likelihood of the bidirectional network communication with the second entity being established by the first entity using one of the candidate communication mechanisms.

14. The computer program product of claim 11, wherein the instructions, when executed by the one or more processors, cause computing the quantitative data by:
counting common data nodes, wherein a common data node is connected to both the first data node and the second data node in the connection graph; and
for each common data node, computing a first connection strength value and a second connection strength value, wherein the first connection strength value is computed by counting data nodes of the connection graph that are connected to both the first data node and the common data node, the second connection strength value is computed by counting data nodes of the connection graph that are connected to both the second data node and the common data node.

15. The computer program product of claim 14, wherein converting the quantitative data to the ordinal data value comprises:
for each common data node, computing a weighted average of the first connection strength value and the second connection strength value;
ranking the common data nodes based on the weighted average;
selecting, as a best option data node, a common data node, based on the ranking; and
for the best option data node, multiplying the weighted average by a parameter value to obtain the ordinal data value.

16. The computer program product of claim 15, wherein the instructions, when executed by the one or more processors, cause incorporating entity data associated with the best option data node into the set of user interface elements.

17. The computer program product of claim 11, wherein the instructions, when executed by the one or more processors, cause computing the quantitative data by:
computing an interaction rate based on second entity interaction data obtained from a logging service that logs electronic interactions of entities using the online software over a time interval,
wherein the second entity interaction data relates to electronic interactions of the second entity with (i) an online news feed or (ii) a set of electronic messages sent to or received from other entities that use the online software or (iii) a combination of (i) and (ii).

18. The computer program product of claim 17, wherein the instructions, when executed by the one or more processors, cause multiplying the interaction rate by a parameter value to obtain the ordinal data value.

19. The method of claim 17, wherein the instructions, when executed by the one or more processors, cause incorporating date/time data associated with the interaction rate into the set of user interface elements.

20. The method of claim 17, wherein the instructions, when executed by the one or more processors, cause incorporating talking point data into the set of user interface elements, wherein the talking point data is determined based on a grouping of second entity interaction data that corresponds to electronic interactions of the second entity with an online news feed.
